(19) United States
(12) Patent Application Publication
(10) Pub. No.: US 2026/0121217 A1
(43) Pub. Date: Apr. 30, 2026

(54) Battery Extinguishing Container

(71) Applicant: FOGTEC Brandschutz GmbH, Köln (DE)

(72) Inventor: Dirk K. Sprakel, Köln (DE)

(21) Appl. No.: 19/148,766

(22) PCT Filed: Jan. 20, 2023
(86) PCT No.: PCT/EP2023/051323

§ 371 Date: Jul. 17, 2025

(51) Int. Cl. H01M 50/383; H01M 10/48; H01M 10/613; H01M 10/6561; H01M 50/358

(52) U.S. Cl. CPC H01M 50/383; H01M 10/48; H01M 10/613; H01M 10/6561; H01M 50/358

(57) ABSTRACT

An energy storage container is proposed which comprises an exhaust air outlet and a feed device. The feed device is arranged to add a dilution fluid to the fire fluid flowing through the exhaust air outlet in the event of a fire.

The subject matter relates to an energy storage container, in particular for storing at least one electrical energy storage device.

A variety of technical areas are currently undergoing progressive electrification. This applies first and foremost to electromobility, but also to the energy supply of households, production facilities and many other areas. It is often necessary to temporarily store currently available electrical power in energy storage systems for later use. This applies in particular to applications in which a continuous energy supply via the electrical distribution grid is not possible. For example, electric vehicles such as cars, ships or airplanes must be able to draw sufficient energy from an energy storage system during their journey. However, energy storage systems are also increasingly being used in stationary applications, for example in domestic grids, where energy provided by renewable energy sources is stored for later use.

Energy storages systems convert electrical energy into potential energy in a variety of ways. Electrochemical energy storage devices are widely used, especially accumulators. These include lead, sodium-nickel chloride, nickel-metal hybrid and lithium-ion accumulators, for example. Other energy storage systems such as hydrogen tanks in combination with fuel cells are also known.

A common disadvantage of many of these energy storage systems is their potential for destruction in the event of a fault. This is because the energy stored in them can be released in an uncontrolled manner instead of being converted into electrical power in a controlled manner. This often leads to the release of a large amount of thermal energy. This thermal energy can release so much power in the short term that parts of the energy storage unit and ultimately parts of its surroundings catch fire. In this case, the emission of hot, sometimes toxic gases at high temperatures is not uncommon.

Fires involving energy storage systems, especially electrochemical energy storage systems, are characterized by the rapid emission of large quantities of highly concentrated toxic and/or corrosive fire fluids, such as gases, at extremely high temperatures. Even if an energy storage system is therefore housed in a closed area in the event of a fire, large quantities of fire fluids must still be removed from this area without placing too much strain on the surroundings.

This results in the object of minimizing the damage that can be caused by an energy storage system in the event of a fault and, in particular, protecting living beings and objects in the vicinity from fire fluids.

The object is solved by an energy storage container according to claim 1 and a method according to claim 15.

The energy storage container is arranged in particular for the permanent storage of at least one energy storage device, in particular an electrical energy storage device. For example, the energy storage container can have at least one receptacle for an energy storage device.

An energy storage device can be arranged in the energy storage container. For example, the energy storage device can be permanently installed in the energy storage container. For example, the energy storage device can be connected to the energy storage container in a force-fit, form-fit and/or material-fit manner. For example, the energy storage device can be integrated with the energy storage container so that the energy storage device cannot be removed from the energy storage container, in particular in a non-destructive manner.

The energy storage container comprises a housing. In particular, the housing comprises at least one or more walls. In particular, the housing can be arranged to accommodate at least one energy storage device. For example, a receptacle for the at least one energy storage device can be formed by the housing. For example, the housing can enclose a receptacle separate from the housing. The receptacle can, for example, have at least one holder for an energy storage device. For example, the holder may be formed as a thread, bolt, clamp, clip, wedge, rule, strap and/or combinations thereof.

In particular, the housing is closed. For example, the housing can be essentially pressure-tight, hermetically sealed, fluid-tight, in particular gas-tight and/or liquid-tight. In particular, the housing can be closable. Alternatively or additionally, the housing can be openable. For example, the housing can comprise at least one closure. The closure can be arranged as a lid, for example. For example, the closure can close at least one or more openings of the housing, in particular at least one opening through which an energy store can be introduced into the housing. For example, the closure can be pressure-tight, hermetically sealed, fluid-tight, in particular gas-tight and/or liquid-tight.

Connections between an interior and an exterior of the housing, for example cables or pipes, can be provided. These can, for example, be guided through a respective wall of the housing by means of pressure-tight and/or fluid-tight feedthroughs.

The energy storage container can, for example, be permanently installed at a location, in particular be permanently connected to at least one element in its environment. For example, the energy storage container can be housed in a building and/or in a vehicle, in particular stationary. The energy storage container can therefore be arranged stationary within its environment, for example. The housing can have fastening means for this purpose, for example. The fastening means can be arranged on the housing and shaped, for example, as recesses for a screw connection. The fastening means allow the housing to be arranged in a fixed position and remain permanently fixed in relation to its surroundings. It is also possible for the energy storage container to be portable.

The housing can, for example, be made at least partially from a heat-resistant and/or fireproof material. For example, the housing can be made of a metal material such as iron and/or steel, a temperature-resistant plastic, a mineral material such as ceramic, concrete and/or masonry and/or combinations thereof.

The energy storage container also comprises at least one exhaust air outlet arranged on the housing. The exhaust air outlet is arranged to fluidically connect an interior of the housing with an exterior of the housing.

In particular, the interior of the housing is at least partially enclosed by the housing. At least one energy storage device can be arranged in the interior of the housing.

The exterior of the housing is at least partially, preferably completely, separated, by the housing, from the interior of the housing, with the exception of the exhaust air outlet. The exterior of the housing surrounds the housing. For example, the volume of the exterior can be many times larger, for example by a factor of 10, 100, 1000 or more, than the volume of the interior of the housing. The exterior of the housing can, for example, be an area of a building in which the energy storage container in question is housed. The exterior space can be, in particular, a basement room, a storage room, a garage, a utility room or the like.

The exhaust air outlet can fluidically connect the interior of the housing with the exterior of the housing. A fluid can therefore flow through the exhaust air outlet from the interior of the housing into the exterior of the housing and/or in the opposite direction through the exhaust air outlet.

Here, in the foregoing and in the following, fluid includes both a gas and/or a liquid. When it is mentioned here, in the foregoing and in the following that a fluid flows or flows, this includes the flowing of a liquid, the flowing of a gas and/or a combination thereof, for example the transportation of droplets carried in a gas.

The exhaust air outlet enables pressure equalization between the interior and exterior of the housing. Particularly in the event of an ignited energy storage unit, i.e. an event of a fire, fire fluids from the interior of the housing can enter the exterior of the housing through the exhaust air outlet. This prevents excessive pressure from building up inside the housing and damaging it.

The exhaust air outlet can have an internal opening, which is arranged in the interior of the housing. Furthermore, the exhaust air outlet can have an external opening, which is arranged in the exterior of the housing. The exhaust air outlet can, for example, have an internal volume. The inner volume can extend from the inner opening to the outer opening and vice versa. The interior of the housing is fluidically connected to the exterior of the housing through the exhaust air outlet, in particular by means of its internal volume.

The exhaust air outlet can, for example, essentially be formed as a pipe. The cross-section of the pipe can be essentially round, for example. Other cross-sections, for example an elliptical, triangular, square, polygonal and/or otherwise shaped cross-section is also possible. In particular, the exhaust air outlet can have at least one wall. The wall limits the internal volume of the exhaust air outlet in relation to its surroundings.

For example, the exhaust air outlet can have a variable cross-section. In particular, the cross-section can increase along a longitudinal extension of the exhaust air outlet. The longitudinal extension can, for example, extend from the inner opening to the outer opening of the exhaust air outlet. For example, the exhaust air outlet can be enlarged in at least one area in the direction from the interior of the housing to the exterior of the housing.

In particular, the exhaust air outlet extends through a wall of the housing. For example, the exhaust air outlet can be formed as part of the housing. It is also possible for the exhaust air outlet to be separate from the housing. The transition between the housing and the exhaust air outlet is particularly pressure-tight and/or fluid-tight.

For example, the exhaust air outlet can be opened and/or closed. When the exhaust air outlet is open, it connects the interior and exterior of the housing. It does not do this when it is closed. A valve, for example a pressure relief valve, a membrane, in particular a rupture disk, another closure and/or combinations of these can be provided for closing and opening the exhaust air outlet. For example, the exhaust air outlet can also be permanently open.

In addition to the exhaust air outlet, there may be other connections between the interior and the exterior. These are preferably impenetrable for the fluid in the housing. For example, these can be a cable feed-through for the energy storage unit or for data lines, an inlet for an extinguishing fluid and/or other connections to the outside.

According to an embodiment, a drain connection can also be provided next to the exhaust air outlet. For example, a drain channel can be connected to the drain connection, which extends from the drain connection into the housing, for example.

The drain connection can be arranged in the outer wall of the housing. The drain connection can be connected to a further fluid-carrying element, for example outside the housing, for example with a force fit or positive fit, for example by means of a thread, which is arranged on the drain connection, for example.

Fluid, in particular a liquid, especially water, can be drained out of the housing via the drain connection. In particular, an extinguishing fluid can be drained out of the housing. For this purpose, a fluid-conducting and, in particular, fluid-tight connection is provided at least indirectly to a target volume such as a sewer, a body of water, a collection tank and/or similar target volumes. Since fluid, in particular water, which has been in direct contact with a damaged energy storage unit, can be chemically contaminated, it may be advisable for the target volume to be closed, for example as a collection tank.

The drain connection can be fitted with a closure. In particular, a non-return valve can be arranged in or on the drain to prevent backflow into the container. An adjustable closure can also be provided. For example, a valve can close and/or keep open the drain, in particular the drain connection and/or the drain channel. The valve can be operated manually, for example. It is also possible to control the valve using an actuator, such as a motor.

The fluid-tightness of the connection between the drain connection and the target volume (e.g. a collection tank) can be realized as described above by a corresponding connection of the drain connection with an adjoining fluid-carrying element, for example a channel, a pipe, a hose or similar. For example, a screw cap can be provided on the drain connection and/or a force-fit, form-fit or other closure. Optionally, a seal is provided on the outlet opening.

In one embodiment, the drain connection is located in a lower area of the housing. This allows the housing to be emptied to a large extent, in particular (almost) completely.

According to an embodiment, an inlet for an extinguishing fluid is provided. The inlet can feed extinguishing fluid into the interior. A valve on the outlet connection can be coupled to the inlet in such a way that the valve is opened in the event of an inflow of extinguishing fluid, otherwise the valve is closed.

It is also possible that only an inlet for an extinguishing fluid is provided, but no drain connection. The housing can therefore also be arranged without a drain or with a drain. In particular, it has been recognized that a single flooding of the housing with an extinguishing fluid can be sufficient for successful firefighting. The housing can be (almost) completely filled with extinguishing fluid during flooding. The housing can also be only partially filled.

In one type of use of the disclosed energy storage container, an extinguishing fluid is introduced into it once, in particular through the inlet for an extinguishing fluid. In particular, no extinguishing fluid is discharged from the energy storage container.

The inlet for an extinguishing fluid can establish a fluidic connection between an exterior of the housing and the interior of the housing. For example, a fluidic cavity, such as a channel, e.g. a pipe or hose, can connect the exterior with the interior of the housing. The inlet for an extinguishing fluid can also be arranged in the interior of the housing, for example completely.

According to one embodiment, the extinguishing fluid is water.

In particular, the extinguishing fluid can be drinking water, or the extinguishing fluid can be an aqueous solution. For example, the extinguishing fluid can be salt water, such as seawater. For example, the aqueous solution may have a salt content of at least 1%, 2%, 3%, 3.5%, 5%, 10%, 15%, 20%, 25% or 30% by mass. The salt content of the extinguishing fluid may comprise, for example, sodium chloride. It has been recognized that an aqueous solution with one of the above salt contents can promote a discharge of the energy storage device by the extinguishing fluid and accelerate the discharge of the energy storage device, so that the stored potential energy of the energy storage device is released in a controlled and spatially distributed manner.

According to an embodiment, a reservoir for the extinguishing fluid is provided, which is fluidically connected in particular to the inlet for extinguishing fluid. The reservoir can, for example, comprise a fluid reservoir, whereby the fluid reservoir can, for example, be arranged as a tank, bottle, bag and/or combinations thereof. For example, the reservoir and/or the fluid reservoir can be arranged at least partially as a pressure vessel. For example, the reservoir, in particular next to the fluid reservoir, comprises a pressure-generating component, for example a gas container, for example a gas cylinder, which is under pressure. The pressure-generating component can also be arranged as a pump or as a part of the reservoir, in particular the fluid reservoir, which is located higher than the housing and/or the inlet for an extinguishing fluid and thus generates hydrostatic pressure. The pressure-generating component is fluidically connected to the fluid reservoir, for example. For example in a storage state, the pressure-generating component does not exert any pressure on the fluid in the reservoir, in particular the fluid reservoir. In a filling state, the pressure-generating component then exerts pressure on the extinguishing fluid and thus conveys it into the housing. Switching between the storage state and the filling state can be realized, for example, with a valve, a switch for supplying power to a pump and/or combinations of these.

According to an embodiment, the reservoir for the extinguishing fluid comprises a pressure vessel in which extinguishing fluid is stored under pressure. According to an embodiment, the reservoir for the extinguishing fluid comprises a fluid reservoir, for example a bottle, and a gas reservoir, for example a gas bottle. The gas cylinder can be opened so that the pressure of the gas drives the extinguishing fluid from the fluid reservoir into the housing. The extinguishing fluid can be water, in particular salt water.

The energy storage container comprises at least one feed device arranged in and/or on the housing. The feed device mixes a dilution fluid with a fire fluid flowing from the interior of the housing into the exterior of the housing through the exhaust air outlet in the event of a fire. For example, the feed device is arranged to add a dilution fluid to a fire fluid flowing from the interior of the housing into the exterior of the housing through the exhaust air outlet in the event of a fire. The feed device can, for example, comprise at least one suitable control means that triggers the addition of dilution fluid to a fire fluid in the event of a fire. For example, the feed device can receive a signal that is indicative of a fire. For example, the feed device itself can also detect a fire, for example by means of a sensor.

A fire occurs in particular when an energy storage device arranged in the energy storage container overheats, catches fire itself and/or sets fire to at least one element of its surroundings. As a rule, fire fluids are produced when an energy storage device and/or components ignited by it catch fire. Fire fluids include in particular gases, smoke, aerosols and or combinations of these. Fire fluids can be very hot and also toxic, irritating, corrosive, harmful to the environment, foul-smelling and/or combinations thereof.

In the event of a fire, large quantities of fire fluids are typically released. The fire fluids released in the event of a fire can escape from the interior of the housing to the outside through the exhaust air outlet. This results in a volume flow of fire fluids through the exhaust air outlet.

Among other things, it was recognized that the fire fluids pose a great danger to the environment of the energy storage container, particularly due to their high concentration of substances that are hazardous to humans, animals and equipment.

It is therefore proposed that, in the event of a fire, the feed device mixes a dilution fluid with the fire fluid entering the outside of the housing through the exhaust air outlet.

The feed device can be arranged in the housing, for example. In particular, the feed device can be arranged partially or completely inside the housing.

For example, the feed device is arranged on the housing. The feed device can be arranged partially or completely in the exterior of the housing, for example on a wall of the housing.

For example, the feed device can be firmly connected to the housing, for example to a wall of the housing, for example with a force-fit, form-fit and/or material-fit. The feed device can also be connected to the housing in such a way that it is at least captive.

The feed device can, for example, be at least partially integrated with the housing. For example, the housing can provide a receptacle for at least part of the feed device.

When the feed device adds a dilution fluid to a fire fluid, this means in particular that the feed device adds a dilution fluid to the fire fluid. Furthermore, an admixture may include mixing the fire fluid and the dilution fluid with each other so that an essentially homogeneous mixing ratio is achieved between the fire fluid and the dilution fluid.

For example, the feed device can be arranged to supply a dilution fluid to the exhaust air outlet in a volume flow that corresponds to a multiple of the volume flow of fire fluides flowing through the exhaust air outlet and/or escaping from the energy storage container. In other words, the dilution fluid can predominate in the resulting mixture of fire fluid and dilution fluid. For example, the feed device can be arranged to provide at least 2, 3, 4, 5, 10, 50, 100, 500 or 1000 times more dilution fluid per unit time than the amount of fire fluid that escapes from the energy storage container per unit time.

The feed device can dispense the dilution fluid. For example, the feed device can be arranged to dispense the dilution fluid in the area of the exhaust air outlet. In particular, the feed device can dispense the dilution fluid within the exhaust air outlet. In this case, the feed device dispenses the dilution fluid directly into the exhaust air outlet and not first into the interior of the housing and from there into the exhaust air outlet.

By discharging the dilution fluid directly into the exhaust air outlet, it is achieved that the fire fluids emerging from the exhaust air outlet are specifically mixed with the dilution fluid and thus rendered harmless. It was also recognized that by mixing the two fluids (fire fluid and dilution fluid) at the exhaust air outlet, a mixing ratio that is as homogeneous as possible is achieved. If the dilution fluid is first fed into the interior of the housing, it cannot be guaranteed that highly concentrated fire fluids will emerge from the exhaust air outlet, at least in some phases of the fire, especially at the beginning. It has also been recognized that by adding the dilution fluid to the exhaust air outlet, it is possible to achieve a release of the dilution fluid that is adapted to the currently escaping volume flow of the fire fluid. In this way, the dilution effect of the dilution fluid on the fire fluid can be kept constant over time, even with variable discharge quantities of fire fluid. In particular, the feed device can be arranged to always provide an instantaneous quantity of dilution fluid adapted to the volume flow of fire fluids.

The exhaust air outlet can have a minimum length, in particular from the position at which the dilution fluid enters the exhaust air outlet. The minimum length can, for example, be 2, 3, 4, 5, 10, 50, 100 or 500 times the diameter of the exhaust air outlet. The minimum length can also be 0.1, 0.2, 0.5, 1, 2, 5, 10, 20, 50 or 100 m, for example. A particularly long exhaust air outlet, from the entry point of the dilution fluid, leads to particularly good mixing between the dilution fluid and the fire fluid.

According to an embodiment, the feed device can be arranged so that in cases other than a fire, in particular in normal operating modes, i.e. in situations in which the energy storage device is not overheated and/or on fire, no dilution fluid is released.

According to an embodiment, the exhaust air outlet comprises at least one feed opening for the feed device. In particular, the feed opening is different from the inner opening and the outer opening of the exhaust air outlet. The exhaust air outlet thus has at least three openings, for example.

For example, the feed opening can comprise an opening in a wall of the exhaust air outlet. The feed opening can also comprise at least one collar or flange. For example, the feed opening can extend tubularly from at least one wall side of the exhaust air outlet. The feed opening can also be surrounded by a collar or flange on both the inner and outer wall sides of the exhaust air outlet.

The feed opening can, for example, function as a connection for the feed device. For example, the feed opening can be connectable and/or connected to a hose, a duct, a pipe and/or combinations thereof. In particular, the feed device can be fluidically connectable and/or connected to the feed opening and thus, in particular, to the exhaust air outlet by means of the feed opening.

The feed opening can also be an opening in the fluid-carrying element. In this case, for example, the fluid-carrying element can be guided into the exhaust air outlet, for example in the form of a tube, hose and/or similar.

The feed opening is an opening from which a dilution fluid emerges, in particular into the exhaust air outlet. A connection for the feed device can be fluidically connected to the feed opening so that the feed device introduces the dilution fluid into the exhaust air outlet. In particular, the position of the feed opening in the exhaust air outlet is constant. The feed opening thus determines, for example, where the dilution fluid is added to the combustion fluid in the exhaust air outlet.

The feed opening can also be part of the feed device.

According to an embodiment, the feed device is fluidically connected to the exhaust air outlet with a dilution fluid outlet. The dilution fluid outlet is part of the feed device.

In particular, the feed device is fluidically connected to the feed opening. In particular, this connection can be made directly. In particular, this means that no further fluid-carrying element is fluidically arranged between the dilution fluid outlet of the feed device and the feed opening. The dilution fluid outlet can also coincide with the feed opening. An indirect connection between the dilution fluid outlet and the feed opening can also be provided.

For example, the exhaust air outlet can have a smaller cross-sectional area in an area downstream of the feed opening in the direction of flow through the exhaust air outlet than an area upstream of the feed opening in the direction of flow. This takes into account the increased volume flow behind the feed opening. With the same flow velocity, a higher volume flow can therefore be achieved after passing through the feed opening.

According to an embodiment, the exhaust air outlet can have a suction device for the fire fluid based on the Bernoulli effect and driven by the flow of the dilution fluid.

For example, the feed opening can comprise at least one outlet within the exhaust air outlet, which specifies a flow direction of the dilution fluid when exiting the feed opening from the outlet, which is at least partially aligned parallel to the direction of extension of the exhaust air outlet and/or the flow direction of the fire fluid within the exhaust air outlet. Alternatively or additionally, the exhaust air outlet can comprise a chamber into which the dilution fluid can flow through the feed opening. The chamber can be open in the direction of flow of the fire fluid and/or closed against the direction of flow of the fire fluid. This provides a flow direction of the dilution fluid in the direction of the flow direction of the fire fluid.

For example, there may be a constriction of the exhaust air outlet in front of the feed opening in the direction of flow, in particular in front of the chamber. The properties of a constriction of the exhaust air outlet are described below. Flowing the dilution fluid through the constriction results in a negative pressure. The negative pressure can draw in the fire fluid. This allows the dilution fluid to draw in the fire fluid by means of the Bernoulli effect and mix with the fire fluid. This can be achieved particularly well if an opening is arranged in the area of the constriction to an area of the exhaust air outlet that carries fire fluid. By arranging the feed opening behind the constriction in the direction of flow, the fire fluid is not only transported out of the exhaust air outlet by the pressure generated in the housing. Instead, the feed device actively transports the fire fluid out of the housing. Particularly high dilution rates can also be achieved by actively transporting the fire fluid using the dilution fluid.

A fluid-carrying element can be connected to the connection piece, which transports the fire fluid onwards from the exhaust air outlet. For example, the fluid-carrying element can be a pipe, a hose, a chimney, a flue and/or combinations of these. The fluid-carrying element can, for example, be open to the environment.

For example, more than one feed opening can be provided, in particular 2, 3, 4, 5, 10, 20 or more. For example, the feed openings can be spaced apart from each other along the direction of flow. The feed openings can also be located at essentially the same position along the direction of flow and be spaced apart from one another along the circumference of the cross-section of the exhaust air outlet.

The dilution fluid outlet is formed, for example, as an opening, a tube, a hose, a connection and/or combinations thereof.

According to an embodiment, the feed device and/or the exhaust air outlet comprises at least one mixing agent. A mixing agent is used to mix a fluid with another fluid. For example, a mixing agent can cause a flow form that deviates from a laminar flow, such as a turbulent flow.

In particular, the mixing means can be arranged at least partially inside the exhaust air outlet. The mixing means can, for example, be arranged in front of a feed opening in the direction of flow.

For example, a mixing means can be shaped as a lamella, which must be passed by fluids flowing through the exhaust air outlet. For example, the lamella can extend from a wall of the exhaust air outlet and cause a change in direction of the fluid flowing through the exhaust air outlet. A mixing means can also be formed, for example, as a sieve, a screw, a constriction, a widening, an undulation and/or combinations thereof.

By providing a mixing agent, a particularly homogeneous mixture of fire fluids and the dilution fluid is achieved.

According to an embodiment, the feed device comprises at least one dilution fluid source.

The feed device can draw dilution fluid from the dilution fluid source.

For example, the dilution fluid source can be arranged as a reservoir. In particular, the reservoir contains, among other things, dilution fluid. The reservoir can also contain essentially only dilution fluid. The reservoir can, for example, be arranged as a pressurized container, such as a gas cartridge and/or gas cylinder. The reservoir can also contain, for example, reactants for a reaction in which the dilution fluid is produced.

The volume of fluid stored in the reservoir can, for example, correspond to a multiple of the volume of the interior of the housing. In particular, the volume of the dilution fluid stored in the reservoir should be considered in an uncompressed, expanded state. For example, if the reservoir is a pressurized bottle, the volume stored in the reservoir is considered to be the volume occupied by the fluid stored in the pressurized bottle in an expanded state. For example, this stored fluid volume may be at least 10, 50, 100, 500, 1000, 5000 or 10,000 times the volume of the interior of the housing.

The dilution fluid source can also include an intake opening. In particular, the intake opening can fluidically connect the feed device to the environment of the energy storage container. By providing an intake opening, the feed device can use the ambient air as a dilution fluid.

According to an embodiment, the dilution fluid outlet is fluidically connected to the dilution fluid source in an open state of the feed device. In the open state, a fluid, in particular the dilution fluid, can thus flow from the dilution fluid source to the dilution fluid outlet.

According to an embodiment, the dilution fluid outlet is fluidically separated from the dilution fluid source in a closed state of the feed device. Accordingly, in the closed state, no fluid can flow from the dilution fluid source to the dilution fluid outlet.

For example, the feed device can comprise a valve, a flap, a pump, another element suitable for closing a fluidic connection and/or combinations of these. This enables the feed device to switch from the open state to the closed state and vice versa.

The feed device can be controllable, for example. In particular, the feed device can be switchable from the open state to the closed state.

According to one embodiment, the feed device comprises a fluid drive.

In particular, the fluid drive is arranged to drive the dilution fluid to the dilution fluid outlet. In particular, the fluid drive is arranged to drive the dilution fluid from the dilution fluid source to the feed opening.

In the present case, driving a fluid from a first area to a second area can mean, for example, that a volume flow is achieved from the first area to the second area. Driving can also mean that a pressure gradient is formed from the first area to the second area. The pressure gradient can cause a volume flow of the fluid from the first area to the second area.

The fluid drive can be an active fluid drive, for example. In this case, the fluid drive absorbs energy, for example electrical, thermal, kinetic, chemical and/or potential energy, for example from an energy storage device, and uses this absorbed energy to transport the dilution fluid. An active fluid drive can, for example, be a pump, such as an electric pump or a pump driven by an internal combustion engine.

A fluid drive, in particular an active fluid drive, can also be formed by a pressurized reservoir, for example. For example, a gas cylinder can be regarded as an active fluid drive. In this case, the reservoir itself acts as a fluid drive.

The feed device and/or the energy storage container can also enable passive transportation of the dilution fluid to the exhaust air outlet. For example, the energy storage container and/or the feed device can be arranged so that the dilution fluid is drawn out of the feed opening driven by the fire fluid flowing through the exhaust air outlet. This can be achieved in particular on the basis of the Bernoulli effect.

The feed device and/or the energy storage container can therefore form and/or comprise a fluid drive based on the Bernoulli effect.

According to an embodiment, the feed opening is arranged in the area of a narrowing of the exhaust air outlet. Here, in the foregoing and in the following, the constriction can in particular represent a local reduction in the cross-section of the exhaust air outlet. The constriction can, for example, comprise a gradual reduction along a longitudinal extension of the exhaust air outlet and/or along the direction of flow of the fire fluides through the exhaust air outlet up to a center of the constriction with a minimum cross-section. In the direction of flow upstream of the center of the constriction, the exhaust air outlet can be widened to the cross-section of the exhaust air outlet downstream of the constriction.

The constriction causes a locally increased flow velocity of a fluid flowing through the exhaust air outlet, in particular fire fluid. According to the Bernoulli effect, the locally increased flow velocity creates an area with a reduced pressure in the exhaust air outlet compared to other areas of the exhaust air outlet. This area is present in particular in the direction of flow of a fluid through the exhaust air outlet in the area of the center of the constriction, in particular in the direction of flow, in particular shortly before the constriction.

The feed opening can be arranged in the area of the constriction. In particular, the feed opening can be located in the direction of flow, especially in the direction of flow shortly before the center of the constriction. If the feed opening is located shortly before the center of the constriction, this can mean that the feed opening is at most 1%, 5%, 10%, 20%, 50% or 100%, preferably between 20% and 80% of a cross-section of the exhaust air outlet, in particular a cross-section before the constriction and/or a cross-section in the area of the constriction. For this purpose, the feed device can also be at most 1 mm, 2 mm, 5 mm, 1 cm, 2 cm or 5 cm, preferably between 1 cm and 5 cm in the direction of flow in front of the center of the constriction.

Because the feed opening is located upstream of the center of the constriction in the direction of flow, the fire fluid first flows through the constriction, which reduces the pressure locally, and then reaches the feed opening at a particularly low pressure.

The feed opening can also be arranged essentially in the center of the constriction.

Alternatively, the feed opening can be arranged downstream of the constriction in the direction of flow. This can be particularly advantageous if the fire fluid is to be drawn out of the interior of the housing by means of the dilution fluid, especially using the Bernoulli effect.

When reference is made here, in the foregoing and in the following, to a first element which is arranged upstream of a second element in the direction of flow, this means that a particle which passes both elements in the direction of flow reaches the second element first and then the first element.

At least one further constriction can be provided upstream and/or downstream of the described constriction of the exhaust air outlet.

The direction of flow of a fluid through the exhaust air outlet, in particular the fire fluid, is directed in particular from the interior of the housing to the exterior of the housing.

According to an embodiment, the feed device comprises at least one cooling device.

In particular, the cooling device is arranged to cool and/or cool down at least part of the dilution fluid. Cooling can also include, for example, preventing heating.

For example, the cooling device is arranged to cool the dilution fluid flowing into the exhaust air outlet. For example, the cooling device can be arranged to cool the reservoir. For example, the cooling device can be arranged to cool only the extinguishing fluid flowing in the direction of the exhaust air outlet.

The cooling device can be active, for example. For example, a Peltier element, a compressor and/or carburetor, another cold-generating element and/or a combination of these can be provided for this purpose.

The cooling device can, for example, also be realized by the reservoir itself. For example, a pressurized reservoir can cause cooling when the dilution fluid it contains escapes, simply by the expansion of the dilution fluid as it escapes. In this case, the cooling device can, for example, comprise a thermally insulating jacket around at least part of the feed device. The thermal insulation can prevent the already cooled dilution fluid from being reheated by the environment. The reservoir can therefore act as a cooling device itself.

According to one embodiment, the dilution fluid can be a gas. For example, the dilution fluid may be partially or substantially completely formed from air. In this context, substantially completely can mean that at least 85%, 90%, 95% or 99%, preferably 85% to 99% of the volume of the dilution fluid is formed by air. For example, the air can originate from the environment of the energy storage container. For example, this can be the ambient air of a room surrounding the energy storage container. The air can also be outside air, for example. This may be the case, for example, if the dilution fluid source comprises an intake opening located outside buildings. At least a part and/or the dilution fluid, which is essentially complete in, can also be formed from one or more inert gases, for example nitrogen. The dilution fluid may also be formed at least partially or completely from oxygen, carbon dioxide and/or combinations thereof, for example. In particular, it has been recognized that an admixture with a reactive gas such as oxygen is possible because the fire fluides usually no longer contain any flammable components per se. Oxygenating the environment of the energy storage container also reduces the chemical hazards to living creatures posed by the asphyxiating gases of an ignited energy storage unit. Reaction-inhibiting gases such as nitrogen or carbon dioxide can be advantageous as dilution fluids to reduce the risk of fire particularly significantly.

According to an embodiment, the energy storage container, in particular the exhaust air outlet, has a fluid breaker. A fluid breaker is an element that reduces the hazardousness of the fluids passing through it for the environment. For example, a fluid breaker can be arranged as a filter, in particular a filter for gases. The filter may include, for example, an electrostatic filter, an activated carbon filter, a catalyst-based filter and/or combinations thereof. The fluid breaker can also be arranged as a flame trap. A flame trap can, for example, comprise a constriction and/or deflection of a fluid-conducting duct, in particular the exhaust air outlet. The fluid breaker can also comprise a siphon, for example. The siphon is characterized in particular by a course of a channel, for example the exhaust air outlet, which has a local minimum in which, for example, a liquid can collect which occupies the entire cross-section of the channel.

In particular, the fluid breaker can be arranged downstream of the feed opening in the direction of flow. When a fire fluid flows through the exhaust air outlet, it first passes through the fluid breaker and only then through the feed opening. This has the effect that the feed device can supply the dilution fluid to the fire fluid, which has already been weakened in its hazardousness by the fluid breaker. This results in a two-stage attenuation of the fire fluid by the solution in question. The protective effect is thus increased. The efficiency of the dilution fluid admixture is also increased compared to a solution without a fluid breaker.

According to one embodiment, the energy storage container comprises at least one sensor.

The sensor is arranged to detect at least one measured value. In particular, the measured value is indicative of a physical variable within the housing. The physical variable can, for example, relate to an energy storage device arranged in the energy storage container. If a measured value is indicative of a physical variable, the measured value allows conclusions to be drawn about the actual value of the physical variable. For example, a temperature sensor can comprise a resistance wire whose resistance value correlates with the temperature. In this case, the measured value can include the resistance value, which is measured via the temperature-dependent resistance. This is indicative of the temperature.

For example, the sensor may comprise a temperature sensor, a gas sensor, a humidity sensor, a smoke detector, an optical sensor, in particular a camera and/or a light barrier, a pressure sensor, a voltage sensor and/or combinations of these.

In particular, the sensor is arranged to detect an impending and/or existing fire on the basis of at least one measured value. The sensor can therefore be used to detect whether the energy store is ignited or not.

The sensor and/or a sensor control device connected to it can, for example, output a signal as soon as a fire is present. For example, the sensor and/or a sensor control device connected to it can output an electrical, optical, acoustic and/or other signal. The signal can, for example, be directed to a control device, in particular an electronic control device. For example, in the event of a fire, the sensor and/or a sensor control device connected to it can use the signal to inform a monitoring system, such as a building monitoring system, that the energy storage unit is on fire. The signal can also be directed to a signal transmitter. The signal transmitter can, for example, be located on the outside of the energy storage container. The signal transmitter can, for example, draw attention to a fire in the form of a light and/or a sound transmitter, in particular a loudspeaker, as soon as it receives the signal from the sensor or a sensor control device connected to it.

The sensor can be connected to the feed device, for example. For example, the sensor can transmit a signal to the feed device in the event of a fire. The feed device can therefore be arranged in particular to receive a signal from a sensor, in particular from the sensor, in particular a signal which is indicative of a fire. The feed device can be arranged to add a dilution fluid to a fire fluid flowing through the exhaust air outlet as a function of the signal.

According to an embodiment, the energy storage container comprises at least one control device. In particular, the control device is arranged, at least among other things, to control the feed device. For example, the control device can control the feed device as a function of at least one measured value detected by the at least one sensor.

The sensor can be arranged to send a signal based on a measured value it detects, for example to the control device and/or to the feed device. The control device and/or the feed device can also read a measured value from the sensor, for example. The control device and/or the feed device does not have to receive the measured value itself for the control to be based on the measured value. Nevertheless, in some embodiments, the control device and/or the feed device can receive the measured value.

The control device can, for example, be arranged to control the feed device in the closed state and/or in the open state, in particular, for example, to transfer the feed device from the closed to the open state or vice versa. For example, the control device can also be arranged to control the fluid drive of the feed device, in particular to switch it on and/or off. The feed device itself can also be arranged to control its state (open or closed) and/or its fluid drive.

The sensor can be connected to the control device and/or the feed device, in particular directly and/or via at least one further element. For example, the sensor can comprise its own sensor control device, by means of which the control device and/or the feed device receives at least one measured value from the sensor. In particular, the connection can be wired and/or wireless.

The feed device can be connected to the control device and/or the feed device, for example by cable and/or wirelessly. The connection can be realized, for example, via at least one cable and/or via a data bus.

For example, the sensor can detect a measured value. Based on the measured value, the sensor, sensor control device, control device and/or feed device can detect a fire. In this case, the control device can control the feed device based on the measured value detected and/or the feed device itself can carry out a corresponding control. For example, the control device and/or the feed device can switch on the fluid drive of the feed device in the event of a fire.

The feed device itself can also be arranged to detect a fire, for example by means of a sensor. There is therefore no need to provide a separate control device for this. The control device can also be part of the feed device.

In particular, the control unit can be arranged on the outside of the housing. In particular, the control unit can be separated from the interior of the housing. For example, the housing, in particular the housing wall, is reinforced and/or thermally insulated in the area of the control device. The control device can also be integrated with the feed device.

A further aspect relates to a method for operating the energy storage container.

In the process, a fire is first detected. In particular, a fire is detected by means of the at least one sensor of the energy storage container. For example, the sensor records a measured value. The measured value can indicate that the energy storage container is in a critical state, for example shortly before or already in an ignited state.

After a fire has been detected, the method comprises controlling the feed device. In particular, a dilution fluid is added to a fire fluid fed through the exhaust air outlet. In particular, a dilution fluid is added to the fire fluid by means of the feed opening.

In particular, the dilution fluid flows directly into the exhaust air outlet, and especially not first into the interior of the housing and from there indirectly into the exhaust air outlet.

The procedure can be carried out in particular by a control device of the energy storage container.

The method can also include flooding the energy storage container, in particular the housing, in particular the interior of the housing, in the event of a fire. During flooding, an extinguishing fluid, for example water, is introduced into the energy storage container, in particular through a connection for extinguishing fluid, for example from a reservoir for extinguishing fluid. For example, continuous or intermittent flooding can be provided, in which an extinguishing fluid is supplied over a period of at least 5 min, 10 min, 20 min, 40 min, 1 h, 2 h, 5 h, 10 h, 24 h, 2 d, 4 d or a week. Excess extinguishing fluid can flow out of the energy storage container, for example via a drain connection. Extinguishing fluid can also vaporize due to the high temperatures of the ignited energy storage device and escape, for example through the exhaust air outlet.

According to one embodiment, the method comprises a single filling of the energy storage container with extinguishing fluid. Draining of the extinguishing fluid is not provided for in this embodiment.

The energy storage container can therefore comprise a control device which is arranged to control and/or carry out the following steps:
detecting a fire, in particular by means of the at least one sensor of the energy storage container, then
Actuating the feed device in such a way that a dilution fluid is added to a fire fluid fed through the exhaust air outlet, in particular by means of the feed opening.

In the following, the subject matter is explained in more detail with the aid of a drawing showing examples of embodiments. The drawing shows:

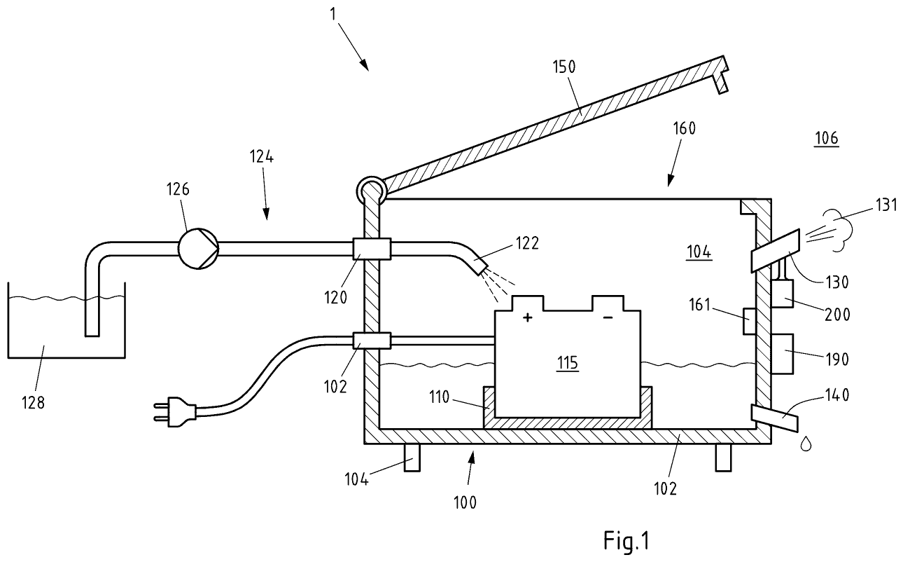

FIG. 1 an energy storage container according to an embodiment;

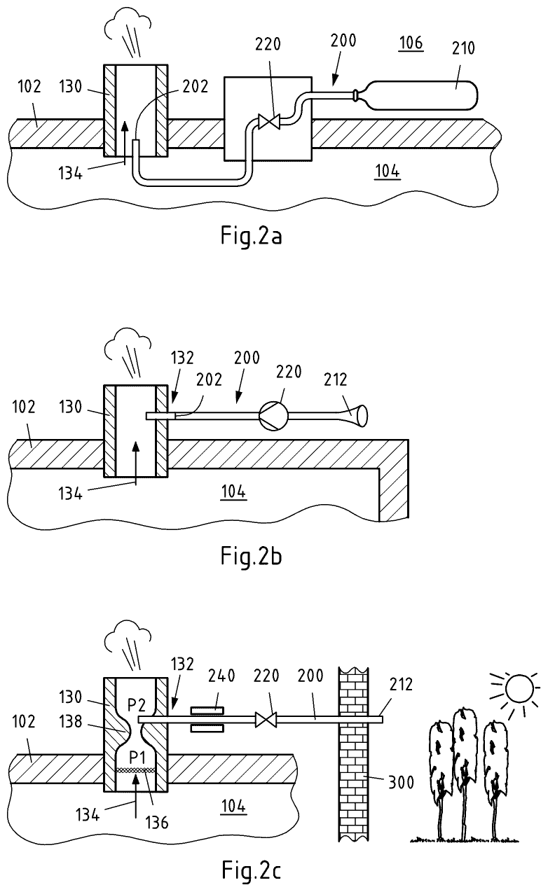

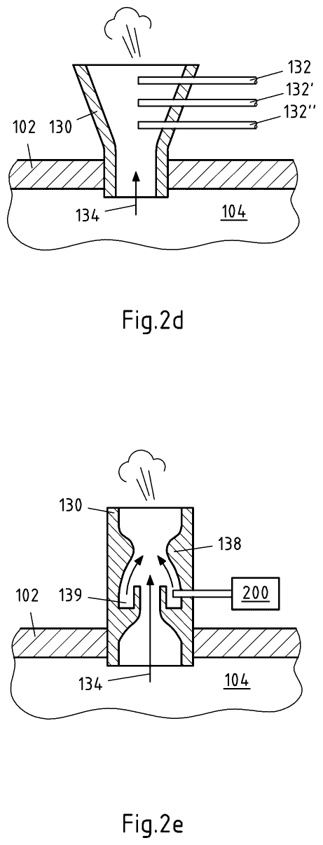

FIG. 2a-e Exhaust air outlets and feed devices according to design examples;

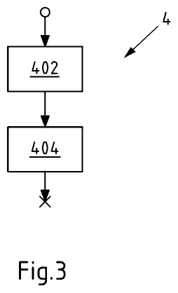

FIG. 3 a method for operating an energy storage container according to an embodiment.

FIG. 1 shows an energy storage container 1 according to an embodiment. This comprises a housing 100 with an opening 160. The opening 160 can be closed by a closure 150. In particular, this closure 150 can close the housing 100 in a pressure-tight or fluid-tight manner, in particular in a gas-tight and/or liquid-tight manner. In some embodiments, the closure 150 can be adjusted between open and closed position by a controllable actuator.

The housing 100 has a connection piece 120 and a connection channel 122, which leads to the receptacle 110. An extinguishing fluid can be conducted through the connection channel 122 to the receptacle 110. The connection piece 120 is connected to a fluid supply 124, which in the example shown comprises a pump 126 that pumps fluid from an extinguishing reservoir 128.

Feet 104 are arranged on the housing 100. These can serve to thermally insulate the housing 100 and/or secure it to the surroundings. A drain connection 140 is provided for draining fluid from the housing 100. Furthermore, a cable feed-through 102 is recessed into the outer wall of the housing 100. A cable can be routed through this to the energy storage unit 115, in particular in a pressure-tight, gas-tight and/or liquid-tight manner.

An exhaust port 130 is located on the housing 100. Fire fluids 131 can escape from the housing 100 through the exhaust port 130. For example, fire fluids 131 may have high temperatures and include, for example, gases, steam, smoke and the like.

FIG. 1 also shows a feed device 200. The feed device 200 is fluidically connected to the exhaust air outlet 130. In this way, fluids, in particular gases, can flow from the feed device 200 to the exhaust air outlet 130. In this way, the fire fluid 131 flowing out of the exhaust air outlet can be diluted.

The housing 100 comprises at least one wall 102. The housing encloses an interior space 104, in particular by means of the wall 102. The interior 104 is separated from the exterior 106 of the housing 100 by the wall 102.

A sensor 161 can be arranged in or on the housing 100. In particular, the sensor 161 can be a temperature sensor, a gas sensor, a smoke sensor and/or an optical sensor. The sensor 161 can be used to monitor the interior of the housing 100. In particular, a state of the energy storage unit 115 can be monitored by means of the sensor 161. In particular, the sensor 161 can be used to detect a fire in the energy storage unit 115.

A control device 190 can also be provided on the housing 100. This can evaluate measured values, which are recorded by the sensor 161, and actuate actuators. In particular, the control device 190 can control the feed devices 200. In particular, the control device 190 can control the feed device 200 based on at least one measured value recorded by the sensor 161.

FIGS. 2a-e show exemplary embodiments of the exhaust air outlet 130 in conjunction with a feed device 200.

FIG. 2a shows an exhaust air outlet 130 which runs through a wall 102 of the housing 100. The wall 102 separates the interior 104 of the housing 100 from the exterior 106 of the housing 100. Starting from the interior 104 of the housing 100 to the exterior 106 of the housing 100, a flow direction 134 runs through the exhaust air outlet 130. The feed device 200 shown comprises a reservoir 210. A dilution fluid can be stored in the reservoir 210. By way of example, a pressurized gas cylinder is shown which functions as reservoir 210. The feed device 200 further comprises a dilution fluid outlet 202. The dilution fluid outlet 202 is arranged within the exhaust air outlet 130. In this way, the feed device 200 can inject the dilution fluid into the exhaust air outlet 130.

The dilution fluid outlet 202 in the embodiment shown can also be referred to as the feed opening if the duct leading thereto is assigned to the exhaust port 130. The feed device comprises a valve 220, which can control the volume flow of the dilution fluid from the reservoir 210 to the exhaust port 230. By means of the valve 220, the feed device 200 can be transferred from an open state to a closed state and vice versa.

FIG. 2b shows an exemplary embodiment of the exhaust air outlet 130, in which a feed opening 132 is provided in a wall of the exhaust air outlet 130. The feed opening 132 can in particular comprise a channel which extends through the wall of the exhaust air outlet 130. In particular, the feed opening 132 can be designated by the inside opening of the duct in the exhaust air outlet 130. Elements projecting beyond the wall may be provided for the feed opening 132, for example tubular collars on both sides.

The feed device 200 is connected to the feed opening 132. A dilution fluid outlet 202 is provided for this purpose. In the embodiment shown, the dilution device 200 further comprises a pump 220.

The dilution fluid source, which was formed by the reservoir 210 in FIG. 2a, can also be shaped as an intake opening 212. The suction opening 212 can serve to suck in the ambient air of the housing 100. In particular, the pump 220 is configured to draw in a gaseous fluid and pump it into the exhaust port 130 at a pressure.

FIG. 2c shows a further embodiment in which the exhaust air outlet 130 comprises a constriction 138. Due to the constriction, a pressure p2 is present in an area in and/or after the constriction, which is lower than the pressure before the constriction p1. In this way, a negative pressure can be generated in the area of the constriction 138. If now, as shown in FIG. 2c, the feed opening 132 is arranged in the region of the constriction 138, in particular in the flow direction 134 upstream of the constriction 138, the dilution fluid can be sucked out of the feed devices 200 by the negative pressure.

FIG. 2c also shows a fluid breaker 136, which may for example be arranged as a filter, a flame trap, a strainer or the like and may make the fire gases escaping from the interior 104 of the housing 100 less hazardous to the environment.

FIG. 2c also shows a cooling device 240. The cooling device 240 can be used to cool a dilution fluid which is fed from the feed device 200 into the exhaust air outlet 230. This can further reduce the danger of the escaping fire gases.

FIG. 2c also shows that gases can be extracted from the environment via the intake opening 212 by means of fluid-carrying elements. For example, a fluid-carrying element of the feed device 200 can penetrate the wall 300 of a building and draw in outside air.

A further embodiment according to FIG. 2d shows an exhaust air outlet 130, which has several feed openings in 132, 132′, 132″. The feed openings 132, 132′, 132″ are spaced apart from one another in the flow direction 134. It is also shown that the exhaust air outlet 130 increases in cross-section in the direction of flow 134. This can prevent the supply of dilution fluid through the feed opening in 132, 132′, 132″ from creating a pressure gradient opposing the flow along the flow direction 134.

FIG. 2c shows the suction of a first fluid (in this case the dilution fluid) by the flow of a second fluid (in this case the fire fluid). This principle can also be used the other way round, so that the flow of the dilution fluid sucks in the fire fluid. Such an arrangement is shown in FIG. 2e.

In FIG. 2e, the exhaust air outlet 130 comprises a chamber 139, which has an opening that is aligned in the direction of flow 134. The chamber is closed against the direction of flow 134. In addition, a constriction 138 is arranged behind the chamber 139 in the direction of flow. If the dilution fluid is now introduced into the chamber 139 by the feed device 200, it flows in the direction of flow 134 (upwards in FIG. 2e) in the direction of the constriction 138. Due to the Bernoulli effect, a negative pressure is generated in the area of the constriction 138. In this way, the fire fluid is drawn from the part of the exhaust air outlet 130 facing the interior 104 of the housing 100 in the direction of the constriction 138 and from there, together with the dilution fluid, is transported further and mixed.

FIG. 3 shows a flowchart of an exemplary method 4 for operating an energy storage container 100.

In step 402, a fire is detected. This is achieved in particular by means of the at least one sensor 161, which is arranged in the housing 100.

In step 404, the feed device 200 is then controlled. In particular, the feed device 200 is controlled in such a way that a dilution fluid is added to a fire fluid fed through the exhaust air outlet 130.

In particular, no dilution fluid is introduced into the exhaust air outlet 130 before the fire is detected.

1-15. (canceled)

16. A method for operating an energy storage container comprising:
providing the energy storage container having a housing arranged to accommodate at least one energy storage device, at least one exhaust air outlet arranged on the housing arranged to fluidically connect an interior of the housing with an exterior of the housing, and a feed device arranged in or on the housing which, in the event of a fire, mixes a dilution fluid into a fire fluid flowing through the exhaust air outlet from the interior of the housing to the exterior of the housing;
detecting a fire by means of at least one sensor of the energy storage container; then
actuating the feed device in such a way that a dilution fluid is added to a fire fluid fed through the exhaust air outlet; and
flooding the housing of the energy storage container with extinguishing fluid.

17. The method for operating an energy storage container of claim 16, wherein the exhaust air outlet comprises at least one feed opening for the feed device.

18. The method for operating an energy storage container of claim 16, wherein the feed device is fluidically connected to the exhaust air outlet via a dilution fluid outlet, in particular to the feed opening, in particular directly.

19. The method for operating an energy storage container of claim 16, wherein the feed device is arranged at least partially or completely inside or outside the housing.

20. The method for operating an energy storage container of claim 16, wherein the feed device and/or the exhaust air outlet comprises at least one mixing means, in particular at least one lamella, a sieve, a screw, a constriction, an expansion, an undulation and/or combinations thereof.

21. The method for operating an energy storage container of claim 16, wherein the feed device comprises a dilution fluid source, in particular
a reservoir containing, in particular, dilution fluid, and/or
an intake opening, which in particular fluidically connects the feed device to the surroundings of the energy storage container.

22. The method for operating an energy storage container of claim 16, wherein in an open state of the feed device, the dilution fluid outlet is fluidically connected to the dilution fluid source and/or in a closed state of the feed device, the dilution fluid outlet is fluidically separated from the dilution fluid source.

23. The method for operating an energy storage container of claim 16, wherein in that the feed device comprises a fluid drive, the fluid drive being arranged in particular to drive the dilution fluid to the feed opening, in particular starting from the dilution fluid source.

24. The method for operating an energy storage container of claim 16, wherein the feed opening is arranged in the area of a constriction of the exhaust air outlet, in particular in a flow direction from the interior to the exterior in front of or behind the constriction.

25. The method for operating an energy storage container of claim 16, wherein the feed device comprises at least one cooling device, the cooling device being arranged in particular to cool at least part of the dilution fluid.

26. The method for operating an energy storage container of claim 16, wherein the dilution fluid is formed at least partially or substantially entirely from air, in particular air from the environment of the energy storage container, and/or from an inert gas, for example nitrogen, and/or from oxygen, carbon dioxide, and/or combinations thereof.

27. The method for operating an energy storage container of claim 16, wherein the energy storage container, in particular the exhaust air outlet, has a fluid breaker, in particular a filter, a flame trap, a siphon and/or combinations thereof, wherein in particular the fluid breaker, in particular in the exhaust air outlet, is arranged in a direction starting from the interior of the housing to the exterior of the housing in front of the feed opening.

28. The method for operating an energy storage container of claim 16, wherein the energy storage container comprises at least one sensor which is arranged to detect at least one measured value, the measured value being indicative of a physical variable within the housing, in particular of a state of an energy storage device arranged in the energy storage container, the sensor being arranged in particular to detect an imminent and/or existing fire on the basis of the at least one measured value.

29. The method for operating an energy storage container of claim 16, wherein the energy storage container comprises at least one control device which is arranged in particular to control the feed device, in particular as a function of at least one measured value detected by the at least one sensor, the control device being arranged in particular to control the feed device into the open and/or closed state and/or the control device being arranged in particular to control the fluid drive, in particular to switch it on or off.
